(19) United States
(12) Patent Application Publication
(10) Pub. No.: US 2022/0322766 A1
(43) Pub. Date: Oct. 13, 2022

(54) Facemask Assemblies

(71) Applicant: OCTO SAFETY DEVICES, LLC, Miami, FL (US)

(72) Inventors: Tobias Franoszek, Miami, FL (US); Natalia Duwin, Miami, FL (US); Alvaro Sanint, Miami, FL (US)

(21) Appl. No.: 17/715,629

(22) Filed: Apr. 7, 2022

Related U.S. Application Data
(60) Provisional application No. 63/172,067, filed on Apr. 7, 2021.

(51) Int. Cl. A41D 13/11; A62B 23/02

(52) U.S. Cl. CPC A41D 13/1138; A41D 13/1192; A62B 23/025; A41D 13/1176

(57) ABSTRACT

In some embodiments, a facemask assembly can include a strap system, a facial skirt, a filter assembly, a filter material, mounting bracket, front section, a tilt mechanism, and/or a seal-tester. In some embodiments, the facial skirt has at least two seal-layers. In some embodiments, the strap system has a crown section.

### CROSS-REFERENCE TO RELATED APPLICATION(S)

This application is related to and claims priority benefits from U.S. Provisional Patent Application Ser. No. 63/172,067 having a filing date of Apr. 7, 2021, entitled “Facemask Assemblies”. The '067 application is hereby incorporated by reference herein in its entirety.

### FIELD OF THE INVENTION

The present invention relates to facemask assemblies. In particular the invention relates to facemask assemblies with seal-testers, facial skirts with multiple seals, strap assemblies, and/or tilt mechanisms.

Facemask assemblies are designed to protect the wearer and others in the vicinity of the wearer from airborne pathogens including bacteria and viruses. Facemasks are typically worn over the mouth and nose and can incorporate a form of eye protection.

Masks can be used in environments with high levels of airborne particulates and/or allergens where the wearer wishes to not inhale said particulates. To effectively reduce a wearer's exposure to airborne substances, a respiratory protection device needs to fit well and effectively filter out said substances.

Preventing inhalation and contact with airborne pathogens and environmental allergens is not only important in environments that require high levels of air purity, such as hospitals, but also in homes of people suffering from allergies. Additionally, wearers suffering from respiratory infections can benefit from the filter capture of pathogens and allergens when out in public.

Conventional masks can be attached to the wearer's head by means of tie straps, elastic straps headbands, and/or nonadjustable holes cut into the mask designed to fit around the wearer's ear. Alternatively, masks can be fastened using elastic straps around the head or ears. Rectangular cross-sectional elastics are often used in one-size-fits-all nonadjustable masks. These masks are often uncomfortable as they can stretch and/or pinch the skin around the ears and back of the head. Similarly, conventional single and double strap systems are often uncomfortable and complicated to adjust to an individual face. This can lead to failure to seal the mask to the face, rendering the mask useless. Conventional masks also do not allow a user to readily adjust the tilt of the mask.

In addition, conventional masks are often required to be disposable as the strapping material tends to capture skin excretions as well as airborne particulates and pathogens and is difficult to clean.

To be effective in reducing a wearer's exposure to airborne substances, a respiratory protection device needs to have a sufficient fit as well as high filtration efficiency. However, conventional masks often provide a poor seal between the mask and the face and/or do not provide a way to easily determine if a proper seal has been formed.

What is needed are facemask assemblies that are easily disinfected/sterilized, are readily adjustable (including the ability to be readily tilted), provide a proper seal on a variety of face sizes and shapes, have a seal that can be easily verified, and/or provide a way to keep the inside of the mask from contamination while not in use.

### SUMMARY OF THE INVENTION

In some embodiments, a facemask assembly can include a strap system, a facial skirt, a filter assembly, a mounting bracket, a first front section, a tilt mechanism, and/or a seal-tester. In some embodiments, the facial skirt can include multiple seal-layers.

In some embodiments, the filter assembly includes a filter material and a filter frame. In some embodiments, the filter frame includes a top piece and a bottom piece configured to sandwich the filter material.

In some embodiments, the strap system includes a crown section.

In some embodiments, the facial skirt has at least two seal-layers. In some embodiments, the facial skirt has at least three seal-layers.

In some embodiments, a facemask assembly can include a second front section, wherein the second front section differs from the first front section. In some embodiments, the second front section is made of a second material and the first front section is made of a first material. In some embodiments, the second front section has of a second shape and the first front section has of a first shape.

The facemask assembly of claim 2 wherein said first front section has at least one clip to attach to said mounting bracket.

In some embodiments, the first front section has a vent.

In some embodiments, the strap system is connected to the mounting bracket via the tilt mechanism.

In some embodiments, the filter frame is curved to fit around a face and is made of a flexible material.

In some embodiments, the filter material has multiple active surfaces.

In some embodiments, the filter material is a spunbond nylon fabric bonded with a silver substrate during the manufacturing process, to which nano fiber is added.

In some embodiments, the filter material is pleated. In some embodiments, the filter material has at least 60% more surface area when compared to a flat filter placed in said filter frame.

In some embodiments, the seal tester is configured to also act as a protective cover of the interior of the facemask assembly.

### BRIEF DESCRIPTION OF THE DRAWINGS

FIG. 1 is a perspective view of a facemask assembly with interchangeable front sections.

FIG. 2 is a perspective view of a facemask assembly showing the configurability provided by the tilt mechanism and strap system.

FIG. 3 is an exploded perspective view of a facemask assembly.

FIG. 4 is an exploded perspective view of a filter assembly and a filter material.

FIG. 5 is a perspective view of a filter assembly and a filter material.

FIG. 6 is a perspective view of another filter assembly and a filter material.

FIG. 7 is a perspective view of another filter assembly and a filter material.

FIG. 8 is a cutaway perspective view of a facemask assembly illustrating a facial skirt with multiple seals.

FIG. 9 is an exploded perspective view of a facemask assembly with a seal-tester being used to verify that a seal has been formed.

FIG. 10 is an exploded perspective view of a facemask assembly with a seal-tester being used to cover the interior of the mask.

### DETAILED DESCRIPTION OF ILLUSTRATIVE EMBODIMENT(S)

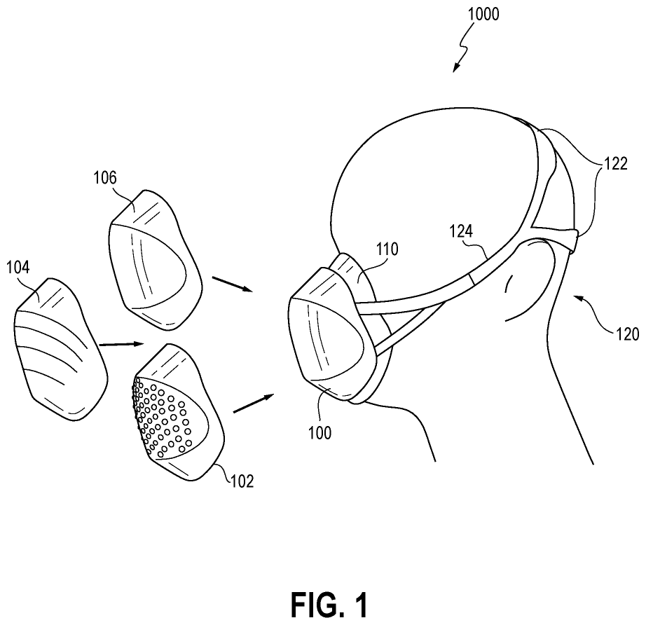

FIG. 1 shows facemask assembly 1000 with interchangeable front sections 100, 102, 104, and 106. In some embodiments, interchangeable front sections 100, 102, 104, and 106 can offer various degrees of protection, filtration efficiency, and/or comfortability. For example, in some embodiments, front section 100 offers greater protection then front section 106. In some embodiments, front sections 100, 102, 104, and 106 can be made of various materials to suit various environments. For example, in some embodiments, front section 100 can be configured to be used in areas with high humidity and front section 104 can be configured to be used in dry areas.

In some embodiments, front sections 100, 102, 104, and 106 can have different shapes to be used with multiple facial structures, allowing a single facemask assembly 1000 to be used by multiple individuals with various facial structures.

In some embodiments, front section 100 has clips to attach to the other parts of facemask assembly 1000. In some embodiments, front section 100 is secured with fasteners such as, but not limited to, screws, bolts, magnets, and/or nuts. In some embodiments, front section 100 supports the extraction of moisture from the mask. In some embodiments, front section 100 can include vents.

In some embodiments, front section 100 can be made of a hard plastic, among other materials. In some embodiments front section 100 is made of a thin plastic material that improves the speech clarity of the user by resonating. In some embodiments, front section 100 can be a rigid or semi-rigid structure constructed from materials such as, but not limited to, various fabrics, polymers, elastomers, plastics, rubbers, and/or silicones. In some embodiments, front section 100 is made of a frame covered by a textile. In some embodiments, front section 100 is large enough to cover the whole face of a wearer.

In some embodiments, front section 100 can be configured to receive mounting bracket 140 when the facemask is assembled. In some embodiments, mounting bracket 140 is plastic. In some embodiments, a front shell clips on to mounting bracket 140 to provide protection for filter assembly 130. In some embodiments, strap system 120 is attached to mounting bracket 140 via tilt mechanism 150 configured to adjust the tilt angle of the mask to the wearer's face.

In some embodiments, front section 102 has clips to attach to the other parts of facemask assembly 1000. In some embodiments, front section 102 is secured with fasteners such as, but not limited to, screws, bolts, magnets, and/or nuts. In some embodiments, front section 102 supports the extraction of moisture from the mask. In some embodiments, front section 102 can include vents.

In some embodiments, front section 102 can be made of a hard plastic, among other materials. In some embodiments front section 102 is made of a thin plastic material that improves the speech clarity of the user by resonating. In some embodiments, front section 102 can be a rigid or semi-rigid structure constructed from materials such as, but not limited to, various fabrics, polymers, elastomers, plastics, rubbers, and/or silicones. In some embodiments, front section 102 is made of a frame covered by a textile. In some embodiments, front section 102 is large enough to cover the whole face of a wearer.

In some embodiments, front section 102 can be configured to receive mounting bracket 140 when the facemask is assembled. In some embodiments, mounting bracket 140 is plastic. In some embodiments, a front shell clips on to mounting bracket 140 to provide protection for filter assembly 130. In some embodiments, strap system 120 is attached to mounting bracket 140 via tilt mechanism 150 configured to adjust the tilt angle of the mask to the wearer's face.

In some embodiments, front section 104 has clips to attach to the other parts of facemask assembly 1000. In some embodiments, front section 104 is secured with fasteners such as, but not limited to, screws, bolts, magnets, and/or nuts. In some embodiments, front section 104 supports the extraction of moisture from the mask. In some embodiments, front section 104 can include vents.

In some embodiments, front section 104 can be made of a hard plastic, among other materials. In some embodiments front section 104 is made of a thin plastic material that improves the speech clarity of the user by resonating. In some embodiments, front section 104 can be a rigid or semi-rigid structure constructed from materials such as, but not limited to, various fabrics, polymers, elastomers, plastics, rubbers, and/or silicones. In some embodiments, front section 104 is made of a frame covered by a textile. In some embodiments, front section 104 is large enough to cover the whole face of a wearer.

In some embodiments, front section 104 can be configured to receive mounting bracket 140 the facemask is assembled. In some embodiments, mounting bracket 140 is plastic. In some embodiments, a front shell clips on to mounting bracket 140 to provide protection for filter assembly 130. In some embodiments, strap system 120 is attached to mounting bracket 140 via tilt mechanism 150 configured to adjust the tilt angle of the mask to the wearer's face.

In some embodiments, front section 106 has clips to attach to the other parts of facemask assembly 1000. In some embodiments, front section 106 is secured with fasteners such as, but not limited to, screws, bolts, magnets, and/or nuts. In some embodiments, front section 106 supports the extraction of moisture from the mask. In some embodiments, front section 106 can include vents.

In some embodiments, front section 106 can be made of a hard plastic, among other materials. In some embodiments front section 106 is made of a thin plastic material that improves the speech clarity of the user by resonating. In some embodiments, front section 106 can be a rigid or semi-rigid structure constructed from materials such as, but not limited to, various fabrics, polymers, elastomers, plastics, rubbers, and/or silicones. In some embodiments, front section 106 is made of a frame covered by a textile. In some embodiments, front section 106 is large enough to cover the whole face of a wearer.

In some embodiments, front section 106 can be configured to receive mounting bracket 140 when facemask 1000 is assembled. In some embodiments, mounting bracket 140 is plastic. In some embodiments, a front shell clips on to mounting bracket 140 to provide protection for filter assembly 130. In some embodiments, strap system 120 is attached to mounting bracket 140 via tilt mechanism 150 configured to adjust the tilt angle of the mask to the wearer's face.

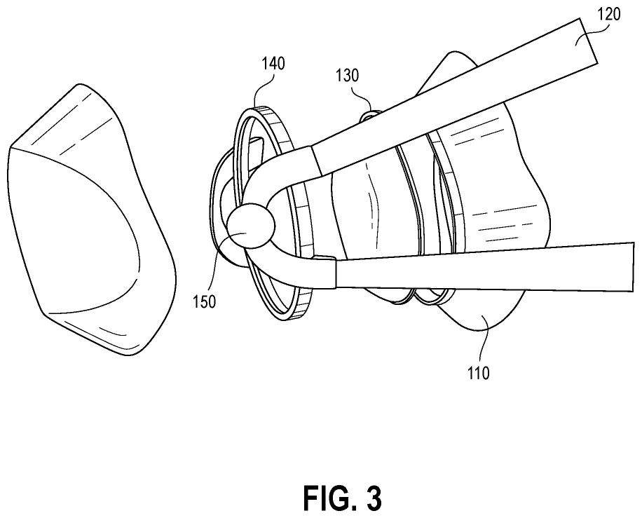

In some embodiments, facemask assembly 1000 includes facial skirt 110. In some embodiments, facial skirt 110 has elastic properties and contacts the face of a wearer. In some embodiments, facial skirt 110 can be constructed from materials such as, but not limited to, soft silicone that conforms to the wearer's face and creates a seal with the wearer's skin. In some embodiments, facial skirt 110 includes an inner perimeter with an opening formed therein that contacts filter assembly 130 (see FIG. 3) when facemask assembly 1000 is assembled, sealing the facemask together. In some embodiments, the outer perimeter of facial skirt 110 has an opening formed therein that fits over the nose and around the mouth of a wearer, sealing facemask assembly 1000 to the wearer's face.

In some embodiments, facial skirt 110 can be customized to a specific wearer, such as for example via additive manufacturing. In some embodiments, facial skirt 110 can be configured to the unique facial topography of a specific wearer. Adjusting various properties of facial skirt 110 such as, but not limited to, its weight, length, width, depth, and/or the shape of the outer perimeter based on the distinct facial structure of the wearer, can create a facemask that optimally conforms to the wearer's face and provides a seal with the skin. A customized facial skirt can also maximize, or at least increase, wearer comfort.

In some embodiments, facial skirt 110, can be made from materials that balance wearer comfort with structural/functional properties: thickness, elasticity, flexibility, coefficient of friction, etc. The materials can provide structural integrity such that the facial skirt conforms to the contours of the wearer's face and creates a seal with the skin. Tactile properties of facial skirt 110 such as smoothness and/or texture of the outer perimeter and/or other surfaces that contact the wearer's skin can be adjusted. In some preferred embodiments, facial skirt 110 can be made from a silicone, silicone-based materials, thermal polyurethanes (TPU) and/or synthetic rubbers.

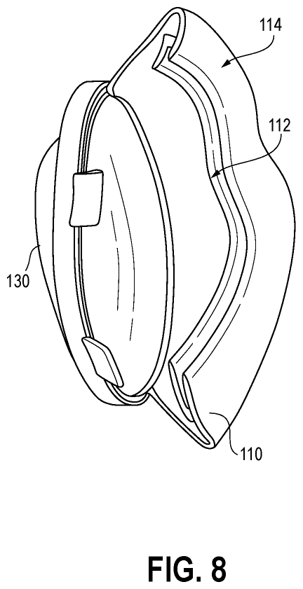

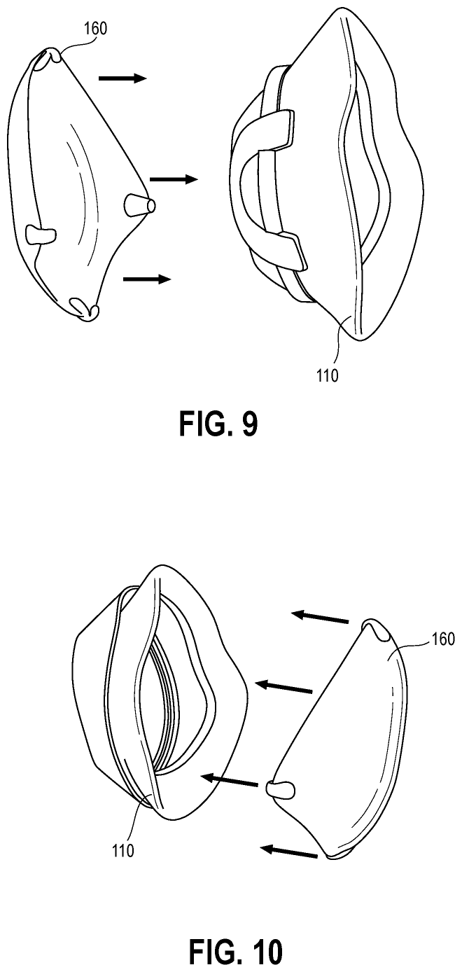

In at least some embodiments, facial skirt 110 includes multiple seal-layers to protect more face shapes and sizes. In some embodiments, such as shown in FIG. 8, facial skirt 110 has two seal-layers, layer 112 and layer 114. In some embodiments, facial skirt 110 has three seal-layers. In some embodiments, facial skirt 110 has four seal-layers. In some embodiments, facial skirt 110 has five seal-layers. In some embodiments, facial skirt 110 has at least six seal-layers.

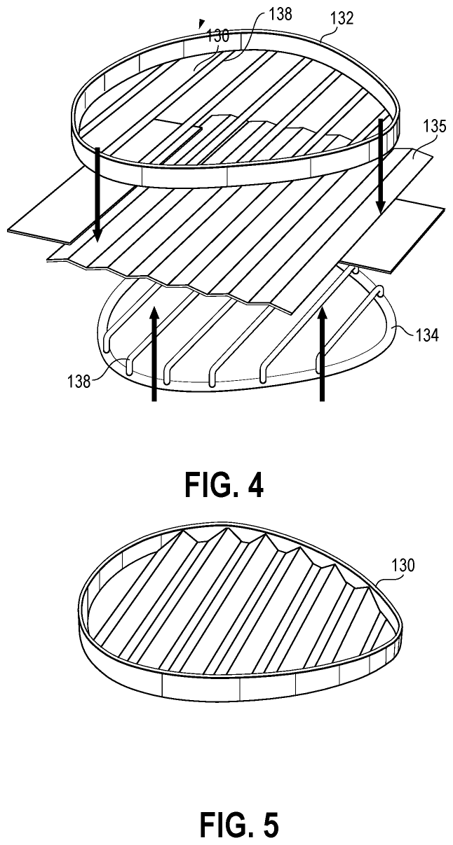

In some embodiments, facemask assembly 1000 includes filter assembly 130. Filter assembly 130 can be configured to hold filter material 135. In some embodiments, filter assembly is made of a filter frame comprising top piece 132 and bottom piece 134 that can sandwich filter material 135 (see FIG. 4 and FIG. 5).

In some embodiments, filter assembly 130 is curved and/or s-shaped. In some embodiments, such as that shown in FIG. 4, filter assembly 130 is flat. In some embodiments, filter assembly 130 is configured to be disposable. In some embodiments, filter assembly 130 is configured to be cleaned and reused while filter material 135 is configured to be disposed.

In some embodiments, filter material 135 has a single active surface. In other embodiments, filter material 135 can have multiple active surfaces. In certain embodiments, the active material contains silver which acts as a biocidal element. In other or the same embodiments, filter material 135 can be optimized for the capture of non-infectious particles such as dust or air pollution particulates or to filter using a chemical and/or biological operation. In some embodiments filter material 135 is a spunbond nylon fabric bonded with a silver substrate during the manufacturing process, to which nano fiber is added.

In some embodiments, filter material 135 releases positively-charged silver ions activated by the moisture of breathing, which inhibit and eliminate microbes and viruses. In some embodiments, filter material 135 is self-cleaning and/or germ-resistant. In some embodiments, filter material 135 is made of a material that reduces the human coronavirus 229E by at least 98% at two hours (ISO 18184:2019 antiviral textile test). In some embodiments, filter material 135 is made of a material that demonstrated a log reduction of 7.0 and a percent reduction of 99.999990. (The JIS L 1902:2015 Antimicrobial Efficacy test).

In some embodiments, filter material 135 is made of a material that shows a mean filtration efficiency of 98% at 60 L/min flow rate on 0.3 micron particle, 2% NaCl with a low pressure drop of only 128 Pa. (TSI 8130).

In some embodiments, filter material 135 reduces the chance of contamination and self-contamination between disinfection and sterilization cycles.

In at least some embodiments, filter material 135 can be used hundreds of times without needing to be replaced.

In some embodiments, filter assembly 130 is configured to accept a pleated filter material (such as shown in FIG. 4). In some embodiments, filter material 135 is positioned between top piece 132 and bottom piece 134. In some embodiments, the filter material is initially flat and becomes pleated as it conforms to horizontal sections 138 of top piece 132 and bottom piece 134 when pressed between frame top piece 132 and bottom piece 134. In at least some embodiments, the pleated shape increases the breathable surface area as well as increases the angularity of the oblique angle of attack experienced by an inhaled particulate and/or pathogen.

In at least some embodiments, the use of a pleated filter between the filter frame increases the surface area of filter material available for interacting with the various particulates, viruses, and the like, by at least 10% more than a flat filter positioned between the filter frame. In at least some embodiments, the use of a pleated filter between the filter frame increases the surface area of filter material available for interacting with the various particulates, viruses, and the like, by at least 20% more than a flat filter positioned between the filter frame. In at least some embodiments, the use of a pleated filter between the filter frame increases the surface area of filter material available for interacting with the various particulates, viruses, and the like, by at least 30% more than a flat filter positioned between the filter frame. In at least some embodiments, the use of a pleated filter between the filter frame increases the surface area of filter material available for interacting with the various particulates, viruses, and the like, by at least 40% more than a flat filter positioned between the filter frame. In at least some embodiments, the use of a pleated filter between the filter frame increases the surface area of filter material available for interacting with the various particulates, viruses, and the like, by at least 50% more than a flat filter positioned between top piece the filter frame. In at least some embodiments, the use of a pleated filter between the filter frame increases the surface area of filter material available for interacting with the various particulates, viruses, and the like, by at least 60% more than a flat filter positioned between the filter frame. In at least some embodiments, the use of a pleated filter between the filter frame increases the surface area of filter material available for interacting with the various particulates, viruses, and the like, by at least 70% more than a flat filter positioned between the filter frame. In at least some embodiments, the use of a pleated filter between the filter frame increases the surface area of filter material available for interacting with the various particulates, viruses, and the like, by at least 80% more than a flat filter positioned between the filter frame. In at least some embodiments, the use of a pleated filter between the filter frame increases the surface area of filter material available for interacting with the various particulates, viruses, and the like, by at least 90% more than a flat filter positioned between the filter frame. In at least some embodiments, the use of a pleated filter between the filter frame increases the surface area of filter material available for interacting with the various particulates, viruses, and the like, by at least 100% more than a flat filter positioned between the filter frame.

In some embodiments, filter material 135 has a single active layer. In other embodiments, filter material 135 has multiple active layers. In certain embodiments, the active material contains silver which acts as a biocidal element. In some embodiments, the active material is silver particles. In some embodiments, the active material is silver nanoparticles. In other or the same embodiments, filter material 135 can be optimized for the capture of non-infectious particles such as dust or air pollution particulates.

In some embodiments, filter material 135 is an antimicrobial material.

In some embodiments, filter assembly 130 is permanently affixed to mask assembly 1000.

In some embodiments, top piece 132 is not needed for the filter assembly 130 and instead mounting bracket 140 operates as the top piece. In some embodiments, filter assembly 130 has a pleated/folded design that positions filter material 135 away from the wearer's face, so that it does not interfere with talking and facial expressions, provides a large filtration area, is more breathable, and/or speeds the evaporation of moisture from within the mask. In some embodiments, filter material 135 filters over 95% of particulates.

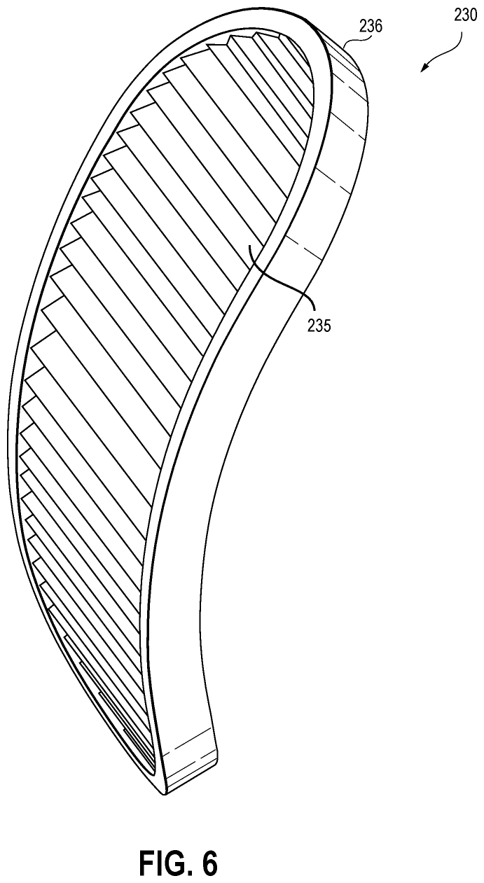

FIG. 6 illustrates filter assembly 230. In at least some embodiments, filter assembly 230 includes filter frame 236 and filter material 235. In the embodiment shown, frame 236 is curved. In at least some embodiments, frame 236 is made of a flexible material. In some embodiments, frame 236 aids in forming a seal. In some embodiments, filter material 235 is pleated. In some embodiments, frame 236 is molded around filter material 235. In at least some embodiments, the pleats of the filter material 235 are configured to run vertically when a user wears facemask assembly 1000. This is found to lead to improvements in a user's comfortability and speech clarity.

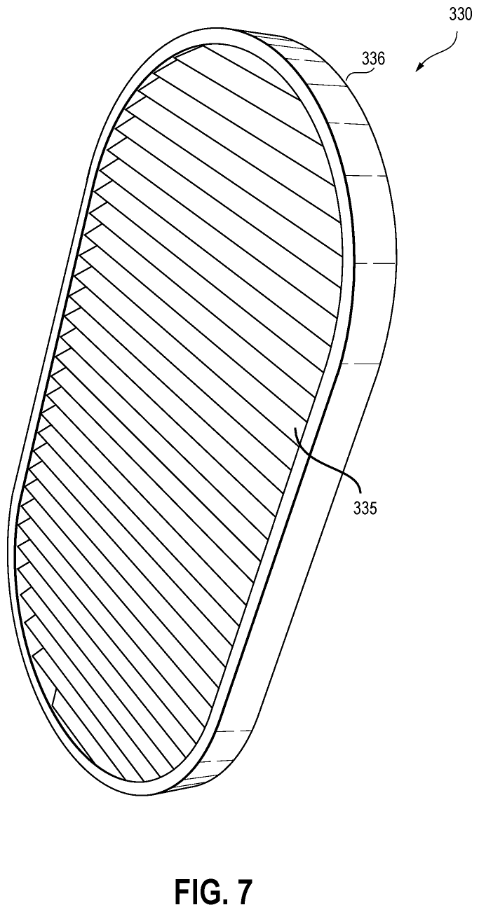

FIG. 7 illustrates filter assembly 330. In at least some embodiments, filter assembly 330 includes filter frame 336 and filter material 33. In at least some embodiments, frame 336 is made of a flexible material. In some embodiments, frame 336 aids in forming a seal. In some embodiments, filter material 335 is pleated. In some embodiments, frame 336 is molded around filter material 335. In at least some embodiments, the pleats of the filter material 335 are configured to run vertically when a user wears facemask assembly 1000. This is found to lead to improvements in a user's comfortability and speech clarity.

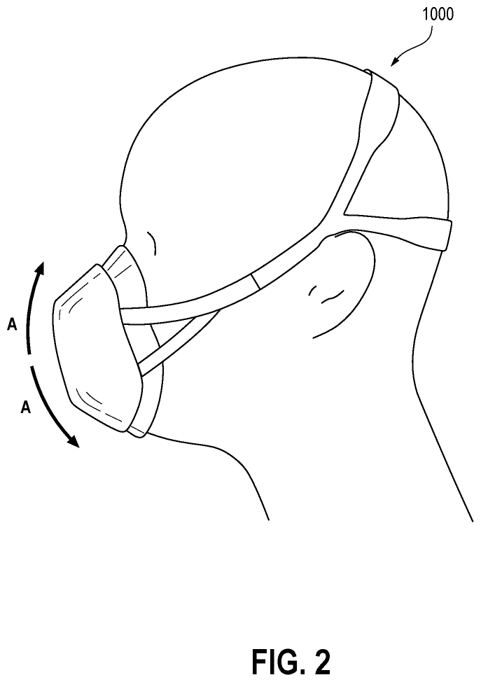

In some embodiments, facemask assembly 1000 includes strap system 120. In some embodiments, strap system 120 is configured to allow for facemask assembly 1000 to tilt as indicated by arrows A in FIG. 2 to form a better fit.

A major factor for any facemask's performance is a complete seal on the wearer's face. With most faces differing in shape and size a careful adjustment of the angle of the mask towards the face can make the difference between a proper seal and having small gaps. The correct angle/tilt can also release pressure on the nose which is a major cause for discomfort for mask wearers.

In some embodiments, strap system 120 is a single strap design. In at least some embodiments, single strap designs are more comfortable to wear and/or easier to use. In some embodiments, this is due to a reduced amount of weight on the wearer's nose. In at least some embodiments, single strap designs allow for the angle of the mask on the face to be easily adjusted while wearing it. In at least some embodiments, single strap designs allow users to don and doff the mask in a single move.

However, traditional single strap designs do not allow for adjustment of the tilt of the mask on the wearer's face. In some embodiments, strap system 120 includes adjustable tilt mechanism 150 (as shown in FIG. 3). In some embodiments, such as shown in FIG. 1, strap system 120 forms crown section 122 configured to be placed at the back of a user's head.

In some embodiments, side straps 124 are connected to crown section 122 and include loops which are configured to be attached to tilt mechanism 150 (see FIG. 3). In some embodiments, tilt mechanism 150 includes channel(s) to receive the loops of side straps 124. In at least some embodiments, tilt mechanism 150 acts as a brake which is released during the adjustment of the loop on the mask. In at least some embodiments, the brake mechanism allows the wearer to adjust the angle of the facemask by simply pressing a specific area or button and by releasing it, thereby securing the selected position.

In at least some embodiments, tilt mechanisms 150 can be pushed from the outside of the mask to release the strap loops. In some embodiments, a single tilt mechanism 150 can release both loops at the same time. In other embodiments, two tilt mechanisms 150, one for each loop, can be used.

In some embodiments, the length of strap system 120 is adjustable. In some embodiments, this is accomplished using a glide, a triglide, a buckle, and/or hook-and-loop fasteners.

In some embodiments, crown section 122 is configured to accommodate ponytails and/or hair buns.

In at least some embodiments, strap system 120 is customized to the face of a wearer.

In some embodiments, facemask assembly 1000, or portions thereof, can be made from polyolefins such as, but not limited to, polyethylene (PE), polypropylene (PP), polytetrafluoroethylene (PTFE), and/or polyvinyl chloride (PVC). In some embodiments, facemask assembly 1000, or portions thereof, can be made from, silicones such as polydimethylsilane (PDMS). In some embodiments, facemask assembly 1000, or portions thereof, can be made from polyacylates such as, but not limited to, polymethyl methacrylate (PMMA). In some embodiments, facemask assembly 1000, or portions thereof, can be made from polyesters such as, but not limited to, polyethylene terephthalate (PET), Polylactic Acid (PLA), polyglycolic acid (PGA), and/or polydioxanone (PDO). In some embodiments, facemask assembly 1000, or portions thereof can be made from polyethers such as, but not limited to, polyether ether ketone (PEEK) and/or polyether sulfone (PES). In some embodiments, facemask assembly 1000, or portions thereof, can be made from polyamide (Nylon), polyurethane (PU), and/or polycaprolactone. In some embodiments, facemask assembly, 1000 or portions thereof, is made of thermal polyurethane (TPU), polyamide (nylon), polyurethane (PU), polyethylene (PE), polypropylene (PP), and/or polytetrafluoroethylene (PTFE).

In some embodiments, the plasticity and flexibility of facemask assembly, 1000 or portions thereof, can be increased with various plasticizers that promote durability of the material.

In some embodiments, the entire mask assembly 1000 can be boiled/autoclaved and is reusable. In some embodiments, mask assembly 1000 can be cleaned by chemical disinfectant methods. In some embodiments, filter material 135 can be designed to be boiled or autoclaved. In some embodiments, strap system 120 can be boiled and/or autoclaved. In certain embodiments, strap system 120 does not need to be disassembled from mask assembly 1000 before being boiled and/or autoclaved. In some embodiments, the entire mask assembly can be cleaned and/or boiled without disassembling it. In some embodiments, mask assembly 1000 can withstand sterilization temperatures in the inclusive range of 100−132° C. In some embodiments, facemask assembly 1000 can withstand sterilization temperatures in the inclusive range of 100−160° C.

In some embodiments, the entire facemask assembly 1000 can be disinfected using sterilization chemicals.

In some embodiments, facemask assembly 1000 is configured to be used at least one-hundred-and-eighty times. In some embodiments, such as when facemask assembly 1000 is used in a hospital setting, filter material is configured to last at least for thirty uses. In some embodiments, such as when facemask assembly 1000 is used in a hospital setting, filter material is configured to last at least for fifty uses. In some embodiments, most, if not all, of the parts of facemask assembly 1000 are replaceable. In some embodiments facemask assembly 1000 has a shelf-life of over a decade.

In at least some embodiments, facemask assembly 1000 includes seal-tester 160. In at least some embodiments, seal-tester 160 can be used to verify that the mask has formed an adequate seal (by blocking the air intake/outtake valves). In at least some embodiments, seal-tester 160 can be used to self-verify that the mask has formed an adequate seal. In at least some embodiments, such as shown in FIG. 10, seal-tester 160 can be used as a protective cover for the interior of the mask when it is not in use. In some embodiments, seal-tester 160 can act as a carrying case for the rest of facemask assembly 1000. In some embodiments, seal-tester 160 includes clips that are configured to attach to facemask assembly 1000.

In some embodiments, facemask assembly 1000 includes diaphragms within resonators that can increase the volume and clarity of the wearer's speech.

In at least some embodiments, facemask assembly 1000 provides bi-directional protection.

In certain embodiments, facemask assembly 1000 can comprise an eye shield. In some embodiments, the eye shield is transparent. In some embodiments, an eye shield can comprise at least one extrusion inserted through a pair of through holes. In certain embodiments, the eye shield can be secured at the nose area of the mask. The eye shield can also rest against the wearer's forehead and/or cheekbones. In most, if not all embodiments, eyeglass can be worn with facemask assembly 1000 without the fear of having them fog up due to the airtight seal. In some embodiments, front section 100, 102, 104, and/or 106 covers the whole face of a wearer and thereby also serves as an eye shield. In at least some embodiments, an integrated loop allows facemask assembly 1000 to be secured to other objects and/or the wearer.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

Furthermore, particular elements of the present invention as described in the embodiments above can be incorporated into facemask assemblies in other suitable combinations or arrangements, for example to suit particular applications.

What is claimed is:

1. A facemask assembly comprising:
a) a facial skirt;
b) a first front section; and
c) a filter assembly comprising
i) a filter material; and
ii) a filter frame.

2. The facemask assembly of claim 1 further comprising:
d) a mounting bracket.

3. The facemask assembly of claim 2 further comprising:
e) a tilt mechanism.

4. The facemask assembly of claim 1 further comprising:
d) a strap system with a crown section.

5. The facemask assembly of claim 1 wherein said facial skirt has at least two seal-layers.

6. The facemask assembly of claim 1 further comprising:
d) a second front section, wherein said second front section differs from said first front section.

7. The facemask assembly of claim 6 wherein said second front section is made of a second material and wherein said first front section is made of a first material.

8. The facemask assembly of claim 6 wherein said second front section has of a second shape and wherein said first front section has a first shape.

9. The facemask assembly of claim 2 wherein said first front section has at least one clip to attach to said mounting bracket.

10. The facemask assembly of claim 5 wherein said first front section has a vent.

11. The facemask assembly of claim 3 wherein a strap system is connected to said mounting bracket via said tilt mechanism.

12. The facemask assembly of claim 1 wherein said facial skirt has at least three seal-layers.

13. The facemask assembly of claim 1 wherein said filter frame comprises a top piece and a bottom piece configured to sandwich said filter material.

14. The facemask assembly of claim 1 wherein said filter frame is curved to fit around a face and is made of a flexible material.

15. The facemask assembly of claim 14 wherein said filter material has multiple active surfaces.

16. The facemask assembly of claim 14 wherein said filter material is a spunbond nylon fabric bonded with a silver substrate during a manufacturing process, to which nano fiber is added.

17. The facemask assembly of claim 14 wherein said filter material is pleated.

18. The facemask assembly of claim 17 wherein said filter material has at least 60% more surface area when compared to a flat filter placed in said filter frame.

19. The facemask assembly of claim 1 further comprising:
d) a seal-tester.

20. The facemask assembly of claim 19 wherein said seal-tester is configured to also act as a protective cover of the interior of the facemask assembly.
